(19) United States
(12) Patent Application Publication
(10) Pub. No.: US 2016/0146951 A1
(43) Pub. Date: May 26, 2016

(54) APPARATUS AND METHOD FOR PHOTON COUNTING DETECTION, AND RADIOGRAPHIC IMAGING APPARATUS

(71) Applicant: SAMSUNG ELECTRONICS CO., LTD., Suwon-si (KR)

(72) Inventors: Jae-chul PARK, Yangju-si (KR); Kang-ho LEE, Osan-si (KR); Young KIM, Yongin-si (KR); Jin-myoung KIM, Hwaseong-si (KR)

(73) Assignee: SAMSUNG ELECTRONICS CO., LTD., Suwon-si (KR)

(21) Appl. No.: 14/946,918

(22) Filed: Nov. 20, 2015

(30) Foreign Application Priority Data
Nov. 20, 2014 (KR) 10-2014-0162952

(51) Int. Cl. G01T 1/24

(52) U.S. Cl. CPC G01T 1/247

(57) ABSTRACT

A photon counting detection (PCD) apparatus and radiographic imaging apparatus including the PCD apparatus are provided. The PCD apparatus includes a negative-feedback resistor instead of a negative-feedback capacitor in a signal amplifying apparatus thereof to minimize a leakage current, circuit noise, and a photoelectric accumulation effect at a high speed, so that an improved image may be obtained.

### CROSS-REFERENCE TO RELATED APPLICATIONS

This application claims priority to Korean Patent Application No. 10-2014-0162952, filed on Nov. 20, 2014, in the Korean Intellectual Property Office, the disclosure of which is incorporated herein in its entirety by reference.

### BACKGROUND

1. Field

Apparatuses and methods consistent with the exemplary embodiments relate to photon counting detection and a radiographic imaging apparatus.

2. Description of the Related Art

Radiographic imaging apparatuses refer to imaging systems for obtaining an internal image of an object, such as a human body or other living things, by irradiating radioactive rays, such as X-rays, towards the object. A radiographic imaging apparatus includes a radiation detector for detecting radioactive rays irradiated towards an object.

A photon counting detection (PCD) apparatus has been proposed to count radioactive photons incident onto a radiation detector. The PCD apparatus, when compared to a conventional detector using an integration scheme, has recently attracted much attention in the field of X-ray detectors because of having some strong advantages regarding a signal-to-noise ratio (SNR) and energy separation.

The PCD apparatus may include a photoelectric transformation material portion for transforming input X-ray photons into electric charges and a reading circuit unit for counting the electric charges transformed in the photoelectric transformation material portion. The electric charges generated in the photoelectric transformation material portion are generated in the form of a packet (a set of the electric charges generated in a photoelectric transformation material by a single light irradiation event), and the generated electric charge packet arrives at an input terminal of the reading circuit unit due to an internal potential difference. In the case of the conventional X-ray PCD apparatus, the electric charges arriving at the input terminal of the reading circuit unit charge a feedback capacitor of an amplification unit and a potential difference between both terminals of the charged feedback capacitor is read as a voltage signal. In this way, the electric charges are changed into the voltage signal. Theoretically, a voltage magnitude is proportional to the amount of electric charges generated in the photoelectric transformation material by the X-ray photons.

The voltage signal generated in this way undergoes further amplification and/or shaping and then is measured depending on a corresponding magnitude through an internal comparison unit and a measurer.

When charging the feedback capacitor with the electric charges, not only the electric charges generated by X-ray irradiation, but also a leakage current or noise current components of the photoelectric conversion material portion may affect charging of the feedback capacitor and may cause a change in the voltage signal of the charged electric charges. As a result, the voltage charged in the feedback capacitor and converted may include an error when compared to an ideal result. In addition, when incident photons have to be counted at high speed, a PCD apparatus using the feedback capacitor as a voltage signal converter may generate image information distorted by overlap with the voltage signal due to a time taken for charging and discharging (e.g., μsec˜msec) the feedback capacitor. In addition, if a leakage current of the photoelectric conversion material portion or an additional leakage current generated in radioactive-ray radiation is continuously accumulated in the feedback capacitor, counting may be impossible, and thus, an additional circuit for compensating for the leakage current is required.

### SUMMARY

Provided are a method and apparatus for PCD, the apparatus having an amplification unit with an improved structure for transforming electric charges input to a reading circuit unit into a voltage signal and amplifying the transformed voltage signal and a radiographic imaging apparatus. A technical problem to be solved by the present exemplary embodiments is not limited to the foregoing technical problems and other technical problems may be addressed.

Additional aspects will be set forth in part in the description which follows and, in part, will be apparent from the description, or may be learned by practice of the presented exemplary embodiments.

According to an aspect of an exemplary embodiment, a photon counting detection (PCD) apparatus includes a photoelectric conversion material portion configured to absorb radioactive rays and to generate an electric-charge signal corresponding to energy of the absorbed radioactive rays, an amplification unit including an active resistor configured to convert the electric-charge signal generated in the photoelectric conversion material portion into a voltage and an amplifier configured to amplify the voltage converted in the active resistor, and a counting unit configured to count a voltage signal converted and amplified in the amplification unit.

The amplification unit may be a negative feedback amplifier.

The active resistor may be connected in parallel to the amplifier.

The active resistor may include a P-channel metal oxide semiconductor field effect transistor (PMOS) transistor active resistor or an N-channel metal oxide semiconductor field effect transistor (NMOS) transistor active resistor.

The active resistor may be a cascode circuit including a plurality of transistors connected to one another.

The PCD apparatus may further include an operation supply source configured to drive the active resistor.

The operation supply source may include a current source or a resistor.

The operation supply source may be a current source configured to supply a bias current to the amplification unit.

The operation supply source may include a resistor control unit configured to control the active resistor.

The PCD apparatus may further include a comparison unit configured to compare the voltage amplified by the amplification unit with a reference voltage.

The amplifier may be an operation amplifier.

The operation amplifier may be a common drain amplifier or a common source amplifier.

The radioactive rays may be X-rays or gamma rays.

According to an aspect of another exemplary embodiment, a PCD method includes absorbing radioactive rays in a photoelectric conversion material portion and generating electric charges corresponding to energy of the absorbed radioactive rays, inputting an electric-charge signal generated in the photoelectric conversion material portion to an active resistor, converting the electric-charge signal input to the active resistor into a voltage by the active resistor and amplifying the voltage, and counting an amplified voltage signal.

The PCD method may further include driving the active resistor through an operation supply source.

The driving of the active resistor may include a current-driving operation of driving the active resistor with a current. The driving of the active resistor includes a resistance-driving operation of driving the active resistor with a driving resistance.

The current-driving operation may include a common current driving operation of driving the active resistor with a current generated by a current source for supplying a bias current to the photoelectric conversion material portion. The active resistor may be driven using the operation supply source.

The PCD method according to another embodiment of the present disclosure may further include comparing a voltage amplified by the amplification unit with a reference voltage and outputting a comparison result.

According to an aspect of another exemplary embodiment, a radiographic imaging apparatus includes a photon counting detection (PCD) apparatus and an image processing unit. The PCD apparatus includes a photoelectric conversion material portion configured to absorb radioactive rays and to generate an electric-charge signal corresponding to energy of the absorbed radioactive rays, an amplification unit including an active resistor configured to convert the electric-charge signal generated in the photoelectric conversion material portion into a voltage and an amplifier configured to amplify the voltage converted in the active resistor, and a counting unit configured to count a voltage signal converted and amplified in the amplification unit. The image processing unit is configured to perform image processing with respect to a detection signal detected by the PCD apparatus.

A PCD apparatus and method and a radiographic imaging apparatus according to disclosed embodiments may prevent image distortion caused by accumulation of a noise component.

A PCD apparatus and method and a radiographic imaging apparatus according to disclosed embodiments may perform high-speed counting.

A PCD apparatus and method and a radiographic imaging apparatus according to disclosed embodiments may minimize energy resolution degradation.

A PCD apparatus and method and a radiographic imaging apparatus according to disclosed embodiments may allow high-speed and voluminous image obtaining in the field of computed tomography (CT) and tomosynthesis.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a block diagram of a PCD apparatus according to an embodiment of the present disclosure;

FIG. 2 is a conceptual diagram of a photoelectric conversion unit of a PCD apparatus and a circuit diagram of a reading circuit unit and an amplification unit according to an embodiment of the present disclosure;

FIGS. 3A, 3B, 3C, 3D, 3E, 3F, 3G, and 3H illustrate configuration examples of an active resistor;

FIGS. 4A and 4B illustrate examples where an active resistor and an amplifier are connected in an amplification unit;

FIGS. 5A, 5B, and 5C are graphs showing a characteristic difference between a noise component of a PCD apparatus according to an embodiment of the present disclosure and a noise component of a conventional PCD apparatus;

FIGS. 6A, 6B, and 6C are graphs showing a characteristic difference between a time resolution of a PCD apparatus according to an embodiment of the present disclosure and a time resolution of a conventional PCD apparatus;

FIG. 7 schematically illustrates a radiographic imaging apparatus according to an embodiment of the present disclosure;

FIG. 8 is a diagram of a radiographic imaging apparatus of FIG. 7;

FIG. 9 is a diagram illustrating an embodiment of a radioactive-ray receiving panel;

FIG. 10 is a diagram illustrating an embodiment of a radioactive-ray receiving panel and a PCD apparatus;

FIG. 11 is a diagram illustrating another embodiment of a radioactive-ray receiving panel and a PCD apparatus; and

FIG. 12 is a flowchart illustrating a method of controlling a radiographic imaging apparatus according to an embodiment of the present disclosure.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects. Expressions such as “at least one of,” when preceding a list of elements, modify the entire list of elements and do not modify the individual elements of the list.

The advantages and characteristics of the present disclosure and methods for achieving the same will become clear from the exemplary embodiments set forth in detail below with reference to the attached drawings. However, the present disclosure is not limited to embodiments to be disclosed below and may be implemented in different ways. Rather, the embodiments are provided to complete the disclosure of the present disclosure and to completely inform those of ordinary skill in the art of the scope of the present disclosure, and the present disclosure is defined by the claims. Throughout the specification, like reference numerals refer to like components, and in the drawings, a size or thickness of each component has been exaggerated for clarity of the description.

Although the terms used herein are generic terms which are currently widely used and are selected by taking into consideration functions thereof, the meanings of the terms may vary according to the intentions of persons skilled in the art, legal precedents, or the emergence of new technologies. Furthermore, some specific terms may be randomly selected by the applicant, in which case the meanings of the terms may be specifically defined in the description of the exemplary embodiment. Thus, the terms should be defined not by simple appellations thereof but based on the meanings thereof and the context of the description of the exemplary embodiment.

Hereinafter, with reference to the accompanying drawings, the present disclosure will be described in detail to allow those of ordinary skill in the art to easily conduct the present disclosure. However, the present disclosure may be implemented in different forms and is not limited to the embodiments described herein. To clearly describe the present disclosure in the drawings, a part that is not related to the description will be omitted.

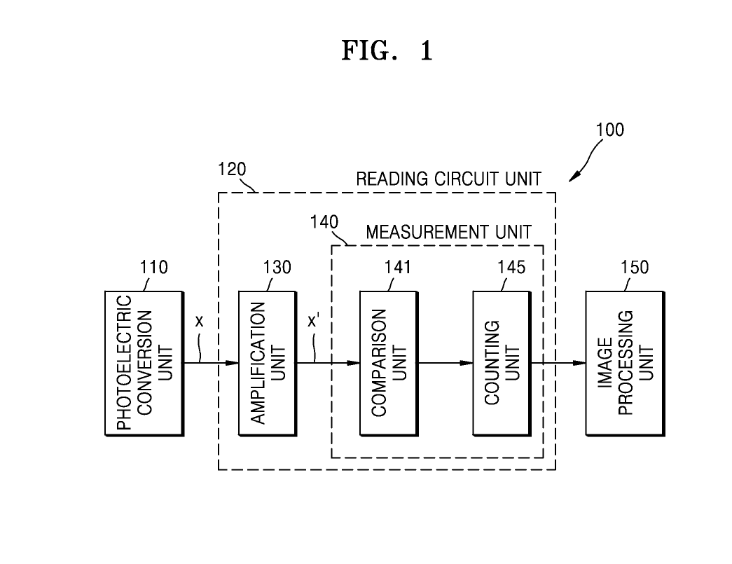

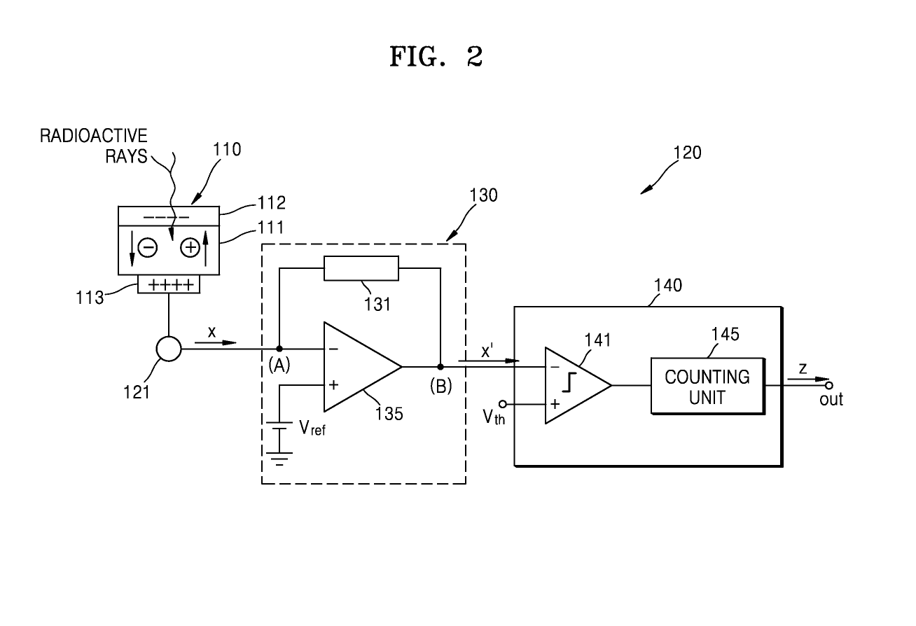

FIG. 1 is a block diagram schematically illustrating a photon counting detection (PCD) apparatus 100 according to an embodiment of the present disclosure, and FIG. 2 illustrates a photoelectric conversion unit 110 and an amplification unit 130 of a reading circuit unit 120 in the PCD apparatus 100.

Referring to FIGS. 1 and 2, the PCD apparatus 100 may include the photoelectric conversion unit 110 and the reading circuit unit 120.

The photoelectric conversion unit 110 receives radioactive rays that are incident from an external source and generates an electric charge packet corresponding to the received radioactive rays. The photoelectric conversion unit 110 may include a photoelectric conversion material portion 111 as illustrated in FIG. 2. The photoelectric conversion material portion 111 may be formed of various types of photoconductor materials that generate electric charges in response to radioactive rays. For example, amorphous selenium or HgI₂ are known as photoelectric conversion materials with respect to X-rays. The photoelectric conversion unit 110 may include an upper electrode 112 and a pixel electrode 113 for outputting the generated electric charges to the photoelectric conversion material portion 111. To form an electric field, a voltage is applied to the upper electrode 112. Once the radioactive rays are irradiated to the photoelectric conversion material portion 111, an electron-hole pair (EHP) is generated in the photoelectric conversion material portion 111, and when a voltage is applied to the upper electrode 112, the EHP is separated into an electron and a hole that are referred to as electric charges. The charges generated in the photoelectric conversion material portion 111 are output to an input pad 121 of the reading circuit portion 120 through the pixel electrode 113. As described below, the PCD apparatus 100 may be a flat panel capable of detecting an image. In this case, a plurality of pixel electrodes 113 may be arranged two-dimensionally to generate an electric signal corresponding to incident radioactive rays for each pixel electrode 113. The upper electrode 112 may be a common electrode. The upper electrode 112 and the pixel electrode 113 have an electrode structure for outputting electric charges generated in the photoelectric conversion material portion 111, without limiting the current embodiment.

The reading circuit unit 120 receives an electric signal generated in the photoelectric conversion unit 110 as an input signal to count photons of the radioactive rays incident onto the photoelectric conversion unit 110 and to output a predetermined resulting signal with respect to the counting. More specifically, the reading circuit unit 120 may include the amplification unit 130 and a measurement unit 140. The amplification unit 130 amplifies, while converting, the input electric signal to allow a voltage to be read. The measurement unit 140 counts the photons based on a voltage of an electric signal x′ amplified in the amplification unit 130. The measurement unit 140 may include a comparison unit 141 for comparing the voltage of the electric signal x′ amplified in the amplification unit 130 with a predetermined reference voltage and a counting unit 145 for counting the photons according to a result of the comparison.

The amplification unit 130 may include an active resistor 131 and an amplifier 135 connected in parallel to the active resistor 131.

A terminal of the active resistor 131 is connected to the input pad 121. The active resistor 131 may be a resistive load circuit including a transistor. For example, the active resistor 131 may include a transistor and a diode or a constant current source circuit including a transistor. The transistor has a relatively small chip area when compared to a resistor (a passive element) or a capacitor. Thus, by implementing the active resistor 131 with a transistor, which is an active element, a chip area of the active resistor 131 in the reading circuit unit 120 may be reduced. A conventional PCD apparatus converts an electric signal input from the photoelectric conversion unit 110 into a voltage across both terminals of the feedback capacitor by charging the input electric signal in the feedback capacitor. The feedback capacitor occupies a relatively large chip area. The electric signal input from the photoelectric conversion unit 110 has a weak strength, whereas the active resistor 131 has a high resistance and thus is useful to convert a fine electric signal into a voltage signal.

The amplifier 135 receives the voltage signal converted by the active resistor 131 and amplifies the voltage signal. The amplifier 135 may be an operational amplifier. The operational amplifier has two input terminals and one output terminal. The amplifier 135 may be connected to the active resistor 131 so that the amplification unit 130 is a negative feedback amplifier. That is, an inversion input terminal (−) and an output terminal of the amplifier 135 are connected to both terminals of the active resistor 131. An input resistance of the amplifier 135 is high or substantially infinite and thus an electric signal (that is, an electric charge packet) input from the input pad 121 flows to the active resistor 131 without flowing to the inversion input terminal (−) of the amplifier 135. The amount of electric charges per time of the electric charge packet flowing through the active resistor 131 may be understood as a current. Thus, according to the Ohm's law, a voltage V across both terminals of the active resistor 131 is:

V=I·R (1),

where I indicates the amount of electric charges per time, of the electric charge packet flowing through the active resistor 131, that is, the current, and R indicates a resistance of the active resistor 131. As can be seen from Equation (1), the magnitude of the voltage V transformed by the active resistor 131 is proportional to the amount of the electric charge packet per time, introduced to the active resistor 131. In other words, the active resistor 131 receives an electric signal in the form of the electric charge packet generated in the photoelectric conversion unit 110 as an input signal and changes the electric signal into the electric signal x′ allowing the voltage to be read. In this way, the electric signal (that is, the electric charge packet) input to the amplification unit 130 is amplified by the amplifier 135 in a state of being linearly read as a voltage in the active resistor 131, such that amplification may be performed at a high speed with respect to the electric signal generated in the photoelectric conversion unit 110.

A resistance R of the active resistor 131 may be controlled by a bias current or a bias voltage applied to the active resistor 131. A proper value of the resistance R of the active resistor 131 may be determined using a size (e.g., a width W and a length L) of a transistor in a manufacturing stage of the PCD apparatus 100.

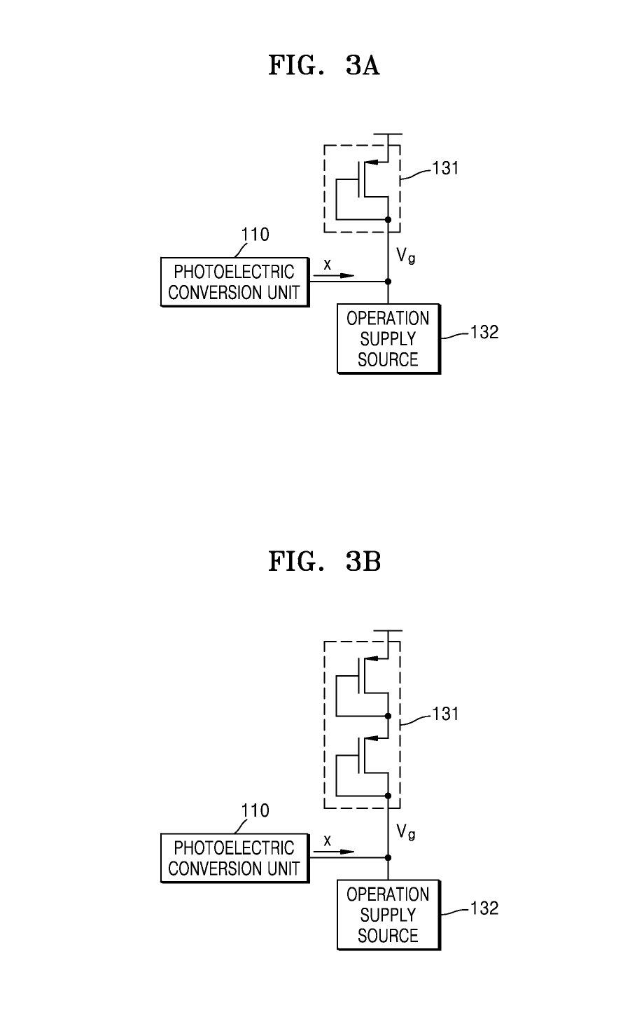

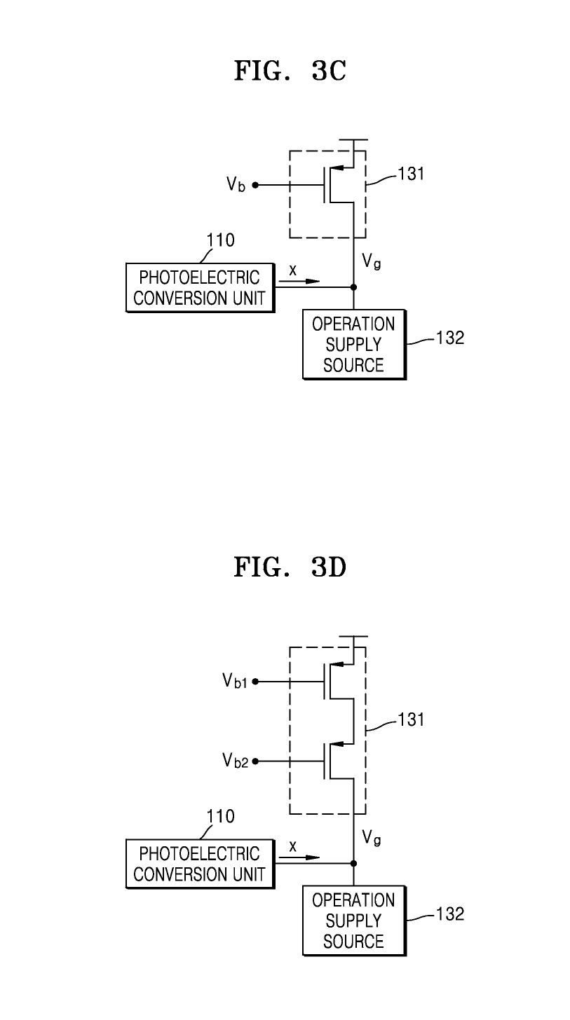

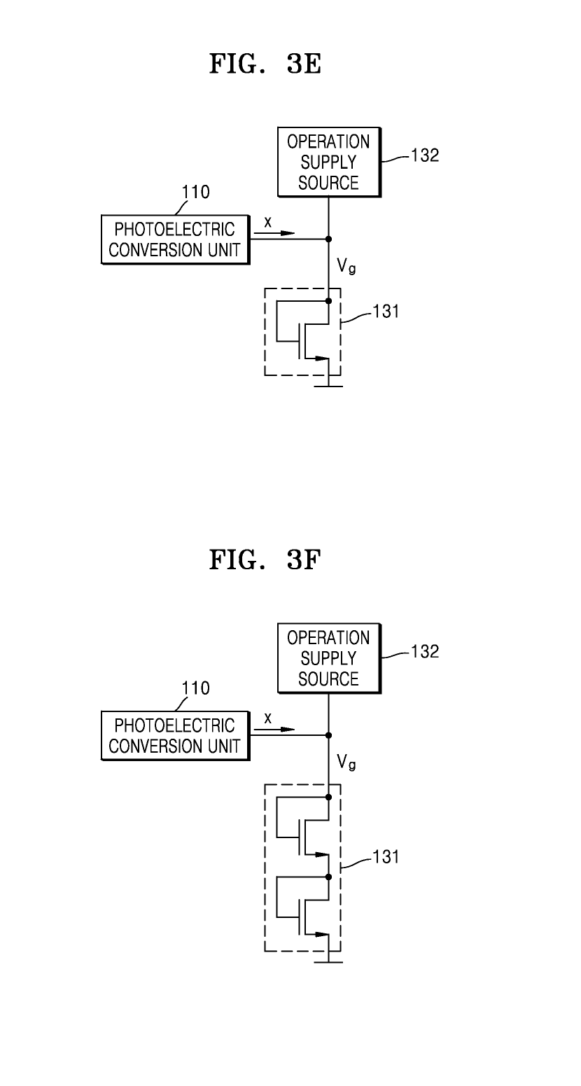

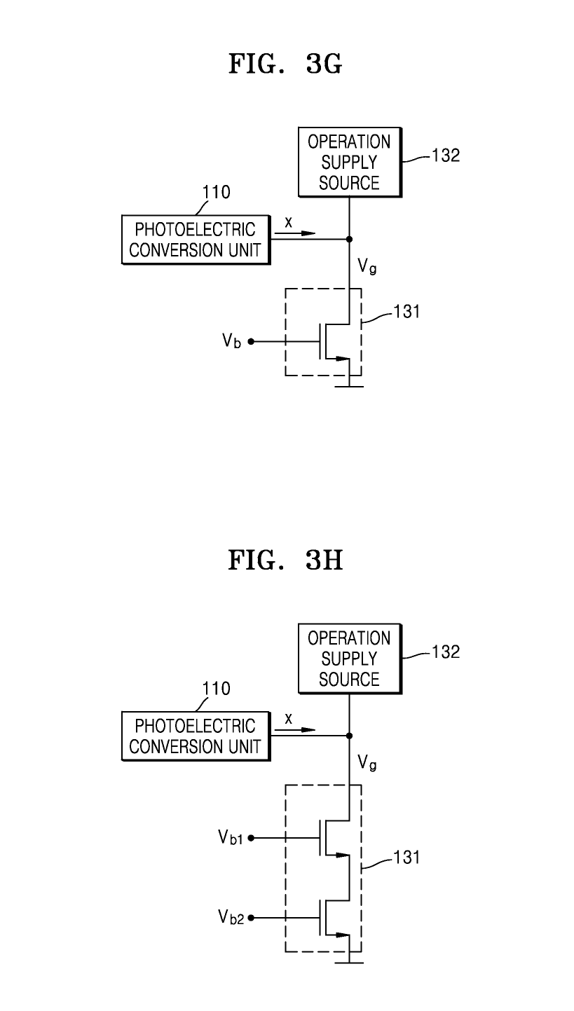

FIGS. 3A through 3H illustrate examples of various circuits of the active resistor 131.

FIG. 3A illustrates an example of the active resistor 131 implemented with a P-channel metal oxide semiconductor field effect transistor (PMOS) transistor in a C-channel metal oxide semiconductor field effect transistor (CMOS) process. As shown in FIG. 3A, the active resistor 131 may be implemented by configuring a diode connecting a gate and a drain of the PMOS transistor as shown in FIG. 3A. The gate/drain of the PMOS transistor is connected to an operation supply source 132 and receives an electric signal from the photoelectric conversion unit 110. The operation supply source 132 may be a constant current source or a constant voltage source. In this case, the voltage read by the active resistor 131 is a gate voltage.

FIG. 3B illustrates another example of the active resistor 131 implemented with a PMOS transistor in a CMOS process. As shown in FIG. 3B, by connecting PMOS transistors whose gate and drain are connected in a cascode manner, a high resistance may be implemented.

FIG. 3C illustrates another example of the active resistor 131 implemented with a PMOS transistor in a CMOS process. As shown in FIG. 3C, a gate of the PMOS transistor is controlled by a bias voltage V_{b}, and a drain of the PMOS transistor is connected to the operation supply source 132 and receives an electric signal from the photoelectric conversion unit 110.

FIG. 3D illustrates another example of the active resistor 131 implemented with a PMOS transistor in a CMOS process. As shown in FIG. 3D, PMOS transistors controlled by bias voltage V_{b1} and V_{b2} are connected in a cascode manner, thereby implementing a high resistance.

FIG. 3E illustrates an example of the active resistor 131 implemented with an N-channel metal oxide semiconductor field effect (NMOS) transistor in a CMOS process. As shown in FIG. 3E, the active resistor 131 may be implemented by configuring a diode connecting a gate and a source of the NMOS transistor as shown in FIG. 3E. A gate/source of a MOS field effect transistor (MOSFET) is connected to the operation supply source 132 and receives an electric signal from the photoelectric conversion unit 110.

FIG. 3F illustrates another example of the active resistor 131 implemented with an NMOS transistor in a CMOS process. As shown in FIG. 3F, by connecting NMOS transistors whose gate and source are connected in a cascode manner, a high resistance may be implemented.

FIG. 3G illustrates another example of the active resistor 131 implemented with an NMOS transistor in a CMOS process. As shown in FIG. 3G, a gate of the NMOS transistor is controlled by the bias voltage V_{b}, and a source of the operation supply source 132 and receives an electric signal from the photoelectric conversion unit 110.

FIG. 3H illustrates another example of the active resistor 131 implemented with an NMOS transistor in a CMOS process. As shown in FIG. 3H, by connecting NMOS transistors controlled by the bias voltages V_{b1} and V_{b2} in the cascode manner, a high resistance may be implemented.

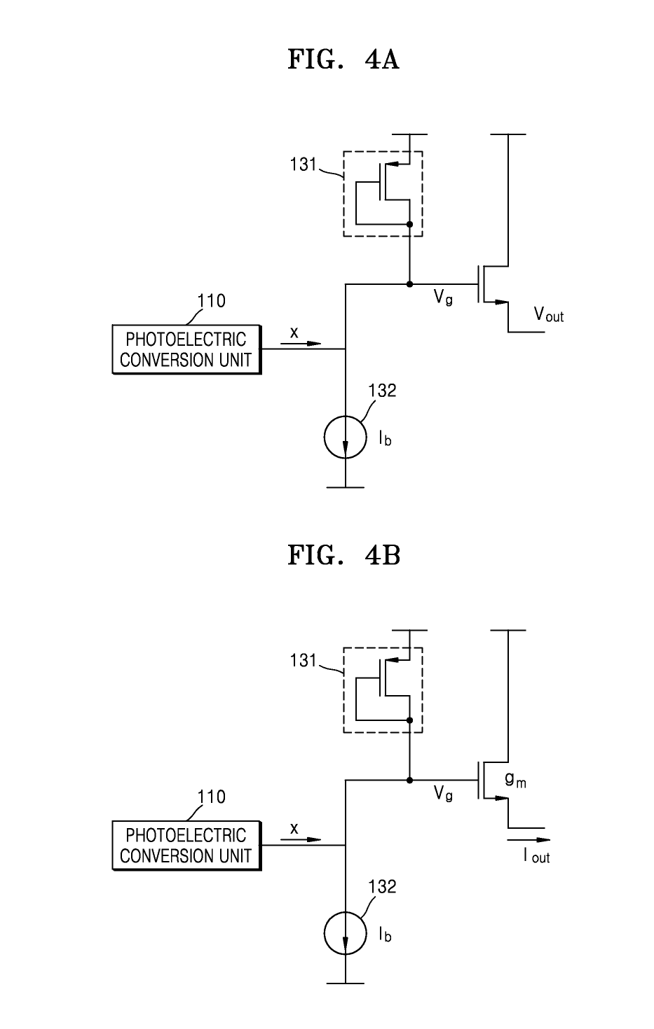

FIG. 4A illustrates an example where the active resistor 131 and an amplifier are connected in the amplification unit 130. Referring to FIG. 4A, the active resistor 131 of the amplification unit 130 is connected to a common drain amplifier. The voltage V_{g} is amplified to a voltage Vₒᵤₜ by the common drain amplifier. The amplified voltage Vₒᵤₜ is delivered to the subsequent comparison unit 141.

FIG. 4A illustrates an example where the active resistor 131 and the amplifier are connected in the amplification unit 130. Referring to FIG. 4A, the active resistor 131 of the amplification unit 130 is connected to the common drain amplifier. The voltage V_{g} is amplified to the voltage Vₒᵤₜ by the common drain amplifier. The amplified voltage Vₒᵤₜ is delivered to the subsequent comparison unit 141.

FIG. 4B illustrates another example where the active resistor 131 and the amplifier are connected in the amplification unit 130. Referring to FIG. 4B, the active resistor 131 of the amplification unit 130 is connected to a common source amplifier. The voltage Vg is amplified to a current Iₒᵤₜ by the common source amplifier.

The amplified current Iₒᵤₜ is delivered to the comparison unit 141.

In this way, the amplification unit 130 recognizes the electric signal delivered using the active resistor 131 as a voltage and amplifies the input electric signal by using the recognized voltage.

Hereinafter, the measurement unit 140 will be described.

The reading circuit unit 120 may further include the measurement unit 140 as shown in FIGS. 1 and 2. The measurement unit 140 receives the electric signal amplified by the amplification unit 130, counts photons by using the received amplified electric signal, and outputs the resulting signal.

More specifically, the measurement unit 140 may include the comparison unit 141 and the counting unit 145.

The comparison unit 141 compares the electric signal amplified by the amplification unit 130 with at least one threshold energy to determine whether the amplified electric signal is greater than or less than the at least one threshold energy and outputs a signal corresponding to a result of the comparison. According to an embodiment of the present disclosure, the comparison unit 141 compares a voltage of the electric signal amplified by the amplification unit 130 with at least one reference voltage Vₜₕ corresponding to the at least one threshold energy to determine whether the voltage of the electric signal is greater than or less than the reference voltage Vₜₕ. In this case, the at least one reference voltage Vₜₕ used for comparison in the comparison unit 141 may be predefined by a user or a system designer. The at least one reference voltage may be determined according to a system setting. The at least one reference voltage may be changed by the user or system when necessary.

The measurement unit 140 may further include a database for storing at least one threshold energy or reference voltage. The comparison unit 141 first reads the database having stored the at least one threshold energy or reference voltage, calls a predetermined reference voltage or threshold energy from the database according to user's selection or system setting, and compares the called predetermined threshold energy with the electric signal amplified in the amplification unit 130.

The comparison unit 141 may generate a predetermined binary signal according to a result of comparison between the amplified electric signal and the threshold energy and output the generated binary signal, according to an embodiment of the present disclosure. For example, the comparison unit 141 may output a signal of ‘1’ if a voltage of the electric signal is the same as the reference voltage or greater than the reference voltage, and may output a signal of ‘0’ if the voltage of the electric signal is smaller than the reference voltage. A signal regarding the result of comparison, such as the binary signal, output from the comparison unit 141 is delivered to the counting unit 145.

The counting unit 145 counts photons over the threshold energy according to a signal delivered from the comparison unit 141 and outputs a resulting signal z for the photon counting. In the radiographic imaging apparatus, the resulting signal z for the photon counting may be used to measure the intensity of radioactive rays. According to an embodiment of the present disclosure, the counting unit 145 may count the number of photons over the threshold energy by counting only the signal of ‘1’ output from the comparison unit 141.

The resulting signal z for the photon counting by the counting unit 145 may be output to an external receiver through an output pad of the reading circuit unit 120. As shown in FIG. 1, the resulting signal z output from the reading circuit unit 120 may be delivered to, for example, an image processing unit 150. The image processing unit 150 may generate an image using a predetermined threshold energy according to the number of photons over the threshold energy.

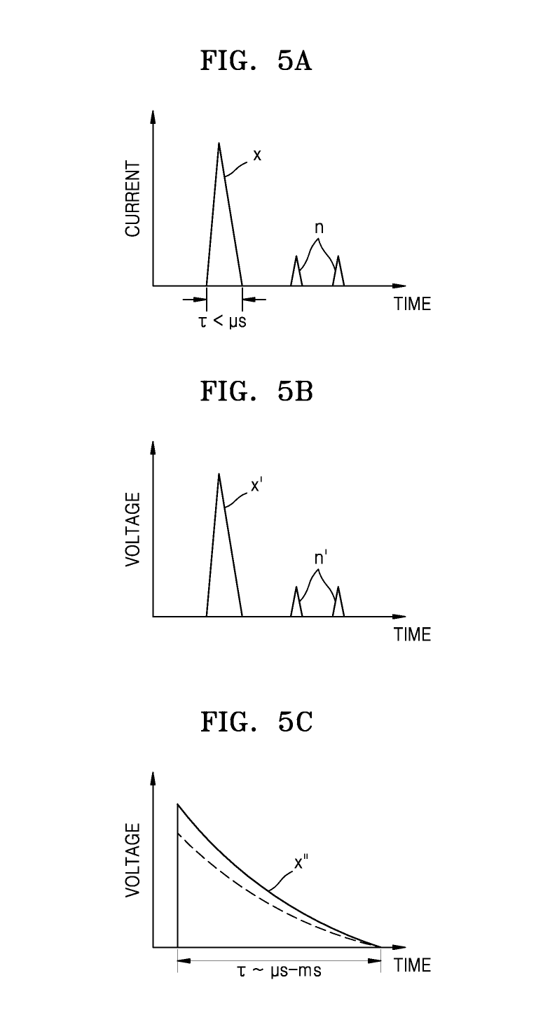

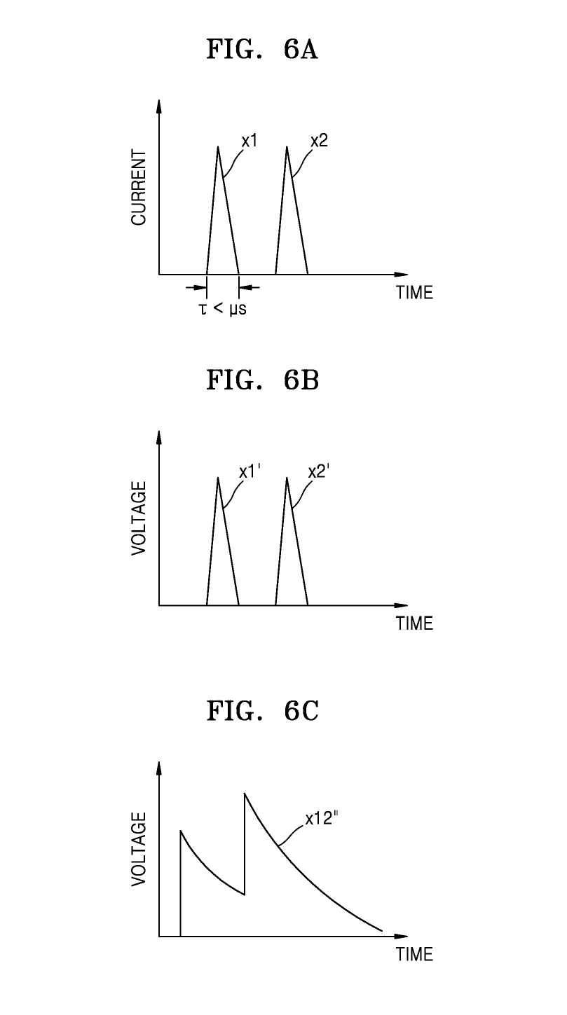

FIGS. 5A through 5C illustrate a characteristic difference between a noise component of a PCD apparatus according to an embodiment of the present disclosure and a noise component of a conventional PCD apparatus.

FIG. 5A is a graph showing an input signal input to the amplification unit 130. Referring to FIG. 5A, if radioactive photons are incident to the photoelectric conversion unit 110, an electric signal x₀ corresponding to the radioactive photons, that is, an electric charge packet is generated in the photoelectric conversion unit 110. For example, if X-rays are irradiated to an object for a short time (e.g., of several μs or less) in an X-ray imaging apparatus, the electric charge packet generated in the photoelectric conversion unit 110 is generated for a time corresponding to a time during which the X-rays are irradiated. In the photoelectric conversion unit 110, leakage current caused by a bias voltage applied to the photoelectric conversion unit 110 or a noise component x_{N} caused by other radioactive rays than the radioactive rays to be detected may be generated. The noise component x_{N} may be continuously generated together with the electric signal x₀ corresponding to the incident radioactive photons and may be input to the amplification unit 130.

FIG. 5B is a graph showing an output signal output from the amplification unit 130 used in the PCD apparatus 100 according to an embodiment of the present disclosure. Referring to FIG. 5B, an output signal output from the amplification unit 130 may include a voltage signal x₀′ corresponding to radioactive ray photons and a voltage signal x_{N}′ corresponding to a noise component. As mentioned above, in the active resistor 131 of the amplification unit 130, a voltage signal has linearity with respect to a flow of input electric charges. That is, the amplification unit 130 according to an embodiment of the present disclosure uses the active resistor 131 instead of the feedback capacitor, such that charging and discharging time associated with the feedback capacitor are not needed for conversion of the flow of the input electric charges into a voltage signal. Thus, the electric charges input to the active resistor 131 show linearity and are immediately converted into the voltage signal, regardless of whether the electric charges are caused by radioactive rays or leakage current. Thus, the voltage signal x_{N}′ caused by the noise component x_{N} may be identified without being mixed with the voltage signal x₀′, and may be removed separately from the voltage signal x₀′ caused by the radioactive rays in a subsequent signal processing stage.

FIG. 5C is a graph showing an output signal output from an amplification unit used in a conventional PCD apparatus. In the conventional PCD apparatus, electric charges generated in the photoelectric conversion unit 110 are converted into a voltage signal while being charged in the feedback capacitor that is feedback-connected to the amplifier, and charging of the electric charges may consume a time of several μs through several ms. During a charging time in the feedback capacitor, not only the electric signal x₀ into which the radioactive photons are converted, but also the noise component x_{N} caused by the leakage current is introduced to the feedback capacitor, such that both the electric signal x₀ into which the radioactive photons are converted and the noise component x_{N} are accumulated in the feedback capacitor, thus being converted into a voltage signal x″. In an amplification unit using a conventional feedback capacitor, the noise component x_{N} accumulated in the voltage signal x″ causes an error in subsequent signal processing and delivers distorted image information. Moreover, in a PCD apparatus using a conventional feedback capacitor, it is difficult to separate the noise component x_{N} from the voltage signal x″ in a subsequent signal processing stage after the amplification unit. For this reason, generally, a compensation circuit for leakage current is provided at the stage of the amplification unit. On the other hand, in the PCD apparatus 100 according to an embodiment of the present disclosure, the voltage signal x_{N}′ caused by the noise component x_{N} may be removed separately from the voltage signal x₀′ caused by the radioactive rays in the subsequent signal processing stage, removing a need for a separate leakage current compensation circuit and thus reducing a pixel design area.

FIGS. 6A through 6C are graphs showing an attribute difference between a time resolution of a PCD apparatus according to an embodiment of the present disclosure and a time resolution of a conventional PCD apparatus.

FIG. 6A is a graph showing a case where radioactive irradiation or radiation is continuously performed at short time intervals such that a first electric signal x1 and a second electric signal x2 are continuously generated.

FIG. 6B is a graph showing characteristics of a voltage waveform output from the amplification unit 130 used in the PCD apparatus 100 according to an embodiment of the present disclosure. As mentioned above, the amplification unit 130 according to an embodiment of the present disclosure uses the active resistor 131 in place of the feedback capacitor, such that a recovery time related to the feedback capacitor is not needed in conversion of the input first electric signal x1 and the input second electric signal x2 into a first voltage signal x1′ and a second voltage signal x2′, and thus the first and second voltage signals x1′ and x2′ output from the amplification unit 130 may be distinguishably separated, even when the first and second electric signals x1 and x2 input to the amplification unit 130 have short time intervals. As a result, even if radioactive rays are irradiated at very short time intervals, photon counting may be performed at a high speed, allowing high-speed image capturing.

FIG. 6C is a graph showing characteristics of a voltage waveform output from an amplification unit along a flow of electric charges shown in FIG. 6A in a conventional PCD apparatus. In the conventional PCD apparatus, electric charges generated in the photoelectric conversion unit 110 are converted into a voltage signal while being charged in a feedback capacitor that is feedback-connected to the amplifier, and for a subsequent signal detection, the feedback capacitor needs discharging.

If a time interval between the first electric signal x1 and the second electric signal x2 that are continuously generated in the photoelectric conversion unit 110 is shorter than a recovery time (e.g., μsec˜msec) of the feedback capacitor, a first voltage signal x1″ and a second voltage signal x2″ that are converted by the feedback capacitor overlap each other and thus are not clearly separated from each other, as shown in FIG. 6C. As a result, information associated with the first electric signal x1 and information associated with the second electric signal x2 are mixed with each other, such that distorted image information is delivered. For computed tomography (CT) or video capturing, radioactive rays are continuously irradiated at predetermined time intervals, and for high-speed image capturing, a time interval for radiation needs to be shortened. However, for an amplification unit using a conventional feedback capacitor, if the time interval between the first electric signal x1 and the second electric signal x2 is shorter than the recovery time of the feedback capacitor, captured radiographic images are not correctly separated, hindering the time interval for radiation from being shortened to be shorter than the recovery time of the feedback capacitor and thus making it difficult to perform high-speed image capturing. When electric charges of the first electric signal x1 and the second electric signal x2 are continuously generated for a shorter time than the recovery time of the feedback capacitor, the first electric signal x1″ and the second electric signal x2″ accumulates continuous information (a pile-up phenomenon) and deliver distorted image information.

The present disclosure provides a reading circuit of X-ray PCD, and relates to an apparatus for converting electric charges corresponding to input photons into a voltage. The present disclosure involves a method for linearly converting input electric charges into a voltage by using an active resistor, unlike a reading circuit using a conventional capacitor that accumulates electric charges. Moreover, through implementation with an active element using CMOS processing, a high resistance may be expected even with a small area. Through the foregoing proposed scheme, high-speed signal processing is possible without accumulation of noise and signal components. As a result, high-speed and accurate measurement is possible when compared to a conventional method, making it possible to obtain images of CT and video X-rays at a high speed without distortion of image information.

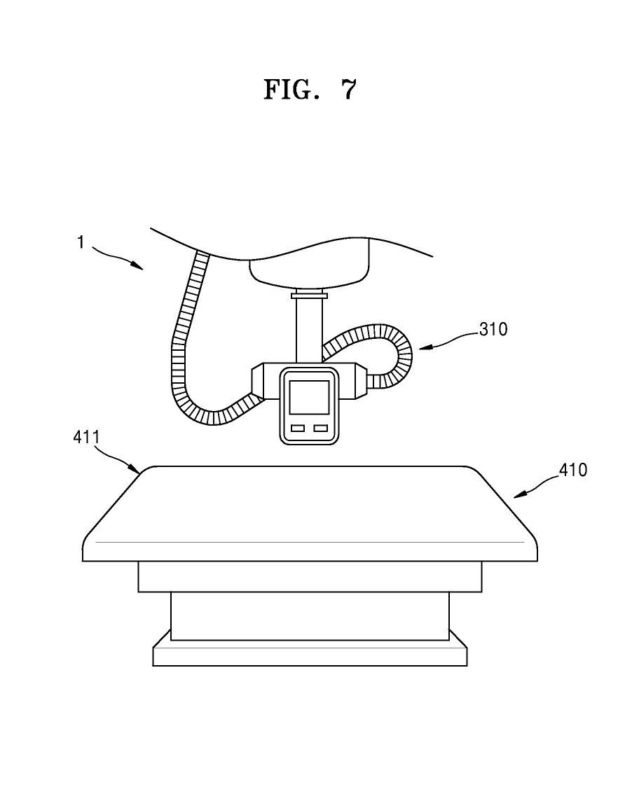

Hereinafter, a radiographic imaging apparatus will be described with reference to FIGS. 7 through 11.

FIG. 7 schematically illustrates a radiographic imaging apparatus 1 according to an embodiment of the present disclosure. Referring to FIG. 7, the radiographic imaging apparatus 1 may include a radiation module 310 and a radioactive cradle portion 410 where a cradle 411 for resting an object thereon is formed. Hereinbelow, for convenience, the radiographic imaging apparatus will be described using a structure illustrated in FIG. 7 as an example, but the described radiographic imaging apparatus is not limited to this example, and may be equally applied to other radiographic imaging apparatuses for counting photons to generate an image, such as a fluoroscopy imaging apparatus, an electrocardiogram measurement apparatus, a mammographic imaging apparatus, or a CT imaging apparatus.

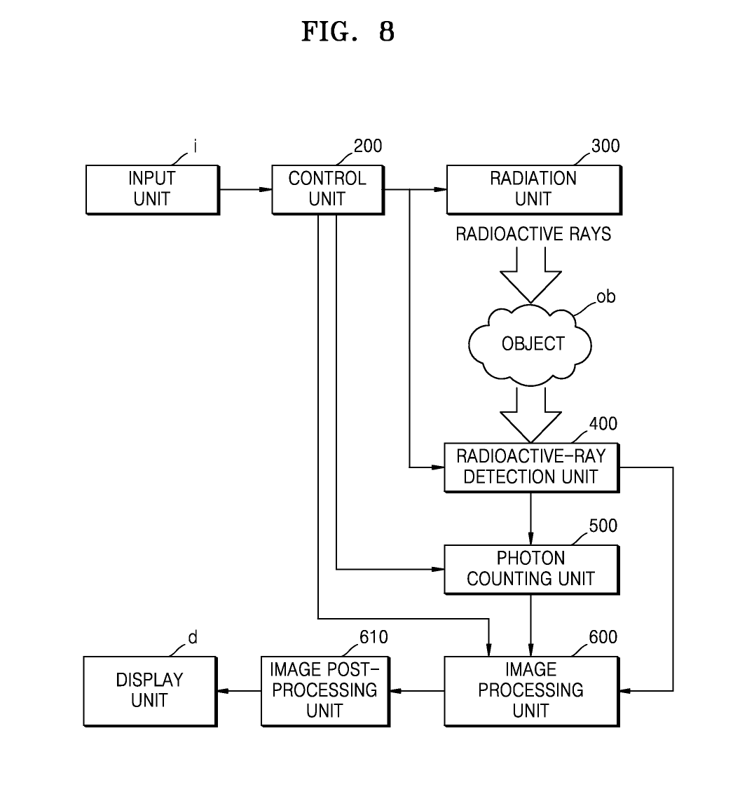

FIG. 8 is a block diagram of the radiographic imaging apparatus 1 according to an embodiment of the present disclosure. Referring to FIG. 8, the radiographic imaging apparatus 1 may include an input unit i, a control unit 200, a radiation unit 300, a radioactive-ray detection unit 400, a photon counting unit 500, an image processing unit 600, an image post-processing unit 610, and a display unit d.

The input unit i receives predetermined information, an instruction, or a command from a manipulator of the radiographic imaging apparatus 1. More specifically, the input unit i receives various information, an instruction, or a command regarding radiography or radiographic image processing, e.g., the number of times of radiation or the amount of radiation, and delivers the input information, instruction, or command to the control unit 200.

According to an embodiment of the present disclosure, the input unit i may include, for example, various user interfaces directly installed in the radiographic imaging apparatus 1, for example, various buttons, a keyboard, a mouse, a trackball, a trackpad, a touchscreen panel, a lever, a handle, a stick, or the like. The input unit i may be directly installed in the radiographic imaging apparatus 1 or may be provided in a separate workstation capable of transmitting and receiving data to and from the radiographic imaging apparatus over a wired/wireless communication network.

The control unit 200 generates a predetermined control command and delivers the generated control command to the radiation unit 300, the radioactive-ray detection unit 400, the photon counting unit 500, or the image processing unit 600, allowing control over overall operation of the radiographic imaging apparatus 1.

More specifically, the control unit 200 receives a user's instruction or command or information input from the input unit i and controls a predetermined operation of the radiographic imaging apparatus 1 by using the delivered instruction or command or information or according to predefined setting.

For example, the control unit 200 may receive a radiographic imaging start command for irradiating radioactive rays to the object ob from the user and control the radiation unit 300 to irradiate radioactive rays to the object ob according to the input radiographic imaging start command.

The radiation unit 300 may include a radiation source for emitting radioactive rays. The radiation source may be, for example, a radioactive tube including a cathode (−) and an anode (+). For example, X-rays are electromagnetic waves having a short wavelength generated by causing electron rays coming from the cathode at a high speed to collide with metal in vacuum discharge. The radiation source emits radiation rays of a predetermined energy to obtain a single energy radioactive image. In another example, the radiation source irradiates radioactive rays having a plurality of different energies to the object ob several times to obtain a multi-energy X-ray (MEX) image. The radiation unit 300 may further include a collimator for controlling a radiation direction or radiation range of radioactive rays. The radiation unit 300 is disposed inside the radiation module 310 shown in FIG. 7 to irradiate radioactive rays to the object ob.

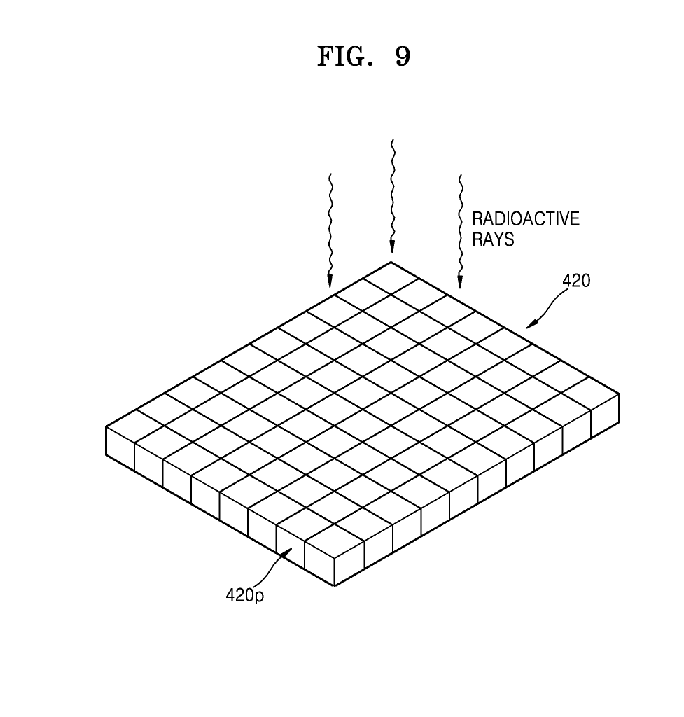

The radioactive-ray detection unit 400 may include a photoelectric conversion unit (110 of FIG. 1) for receiving radioactive rays radiated from the radiation unit 300 and converting the radioactive rays into an electric signal. The radioactive-ray detection unit 400 may be formed on an inner surface of the cradle 411 of the radioactive cradle portion 410 to receive radioactive rays that are irradiated from the radiation unit 300 and pass through the object ob. If the radiation module 310 where the radiation unit 300 is installed irradiates radioactive rays from above as shown in FIG. 7, then the radioactive-ray detection unit 400 may be installed under the cradle 411 of the radioactive cradle portion 410. [99] FIG. 9 is a diagram illustrating an embodiment of a radioactive-ray receiving panel. Referring to FIG. 9, the radioactive-ray detection unit 400 is a detector of a flat panel type and may include a pixel array 420 divided into at least one or more pixels 420p. Each pixel 420p of the PCD apparatus 100 may generate an electric signal corresponding to radioactive rays arriving at each pixel 420p and convert the electric signal into a radioactive signal corresponding to the received radioactive rays. In another embodiment of the present disclosure, upon arrival of radioactive rays, each pixel 420p outputs visible photons corresponding to the arriving radioactive rays, senses the visible photons, generates an electric signal corresponding to the sensed visible photons, and converts the radioactive rays into a corresponding radioactive signal.

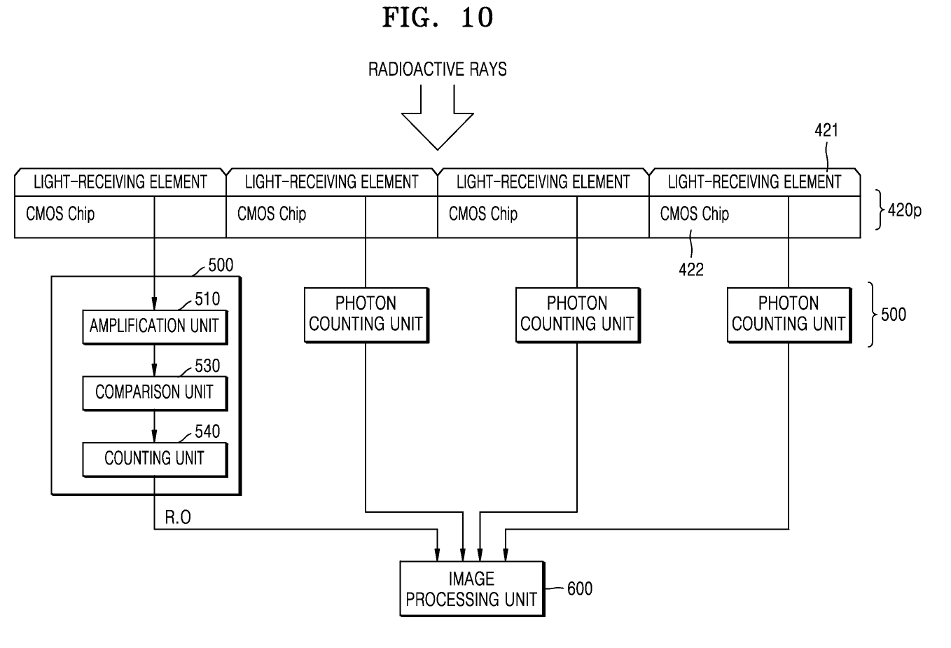

FIG. 10 is a block diagram of each pixel 420p of a PCD apparatus 100 according to an embodiment of the present disclosure.

Referring to FIG. 10, each pixel 420p of the PCD apparatus 100 may include a photoelectric conversion unit including a light-receiving element 421 and the photon counting unit 500. The photoelectric conversion unit may include the photoelectric conversion unit 110 and a CMOS chip 422 where the photoelectric conversion unit 110 is installed. The photoelectric conversion unit 110 may convert radioactive rays received in a direct manner into a predetermined electric signal, that is, a radioactive signal. For example, the photoelectric conversion unit 110 may be a photoconductor. The photoelectric conversion unit may output a predetermined electric signal corresponding to radioactive rays, that is, a radioactive signal according to the received radioactive rays. The radioactive signal output from the photoelectric conversion unit may be directly output to the photon counting unit 500. The output radioactive signal may be an electric charge packet that may include negative electric charges.

The photoelectric conversion unit may be electrically connected with the photon counting unit 500. The photon counting unit 500 counts photons over a threshold energy to obtain information about predetermined data necessary for generation of a radioactive image, e.g., information about the intensity of radiation.

The photon counting unit 500 may include the amplification unit 510, the comparison unit 530, and the counting unit 540.

The amplification unit 510 may include the amplifier 135 and the active resistor 131 that is feedback-connected in parallel to the amplifier 135. A negative input terminal of the amplifier 135 may be connected with an input terminal connected with the photoelectric conversion unit 110 from which the radioactive signal is output, and a positive input terminal of the amplifier 135 may be connected with a reference voltage. The amplification unit 510 converts the input radioactive signal, that is, the electric charge packet into a voltage through the active resistance 131 and is amplified by the amplifier 135. The amplification unit 510 may use the amplification unit 130 according to the foregoing embodiments described with reference to FIGS. 1 through 15.

The comparison unit 530 compares the electric signal amplified by the amplification unit 510 with a threshold energy to determine whether the amplified electric signal is greater or less than a threshold energy, and outputs a comparison result signal. The comparison result signal may be a binary signal. For example, if the amplified electric signal is greater than the threshold energy, the comparison result signal may be 1; on the other hand, if the amplified electric signal is less than the threshold energy, the comparison result signal may be 0.

The counting unit 540 counts photons over the threshold energy by using the comparison result signal delivered from the comparison unit 530 and outputs counting result information regarding the photons. The counting result information may include the intensity of radiation.

The output counting result information may be read by the image processing unit 600.

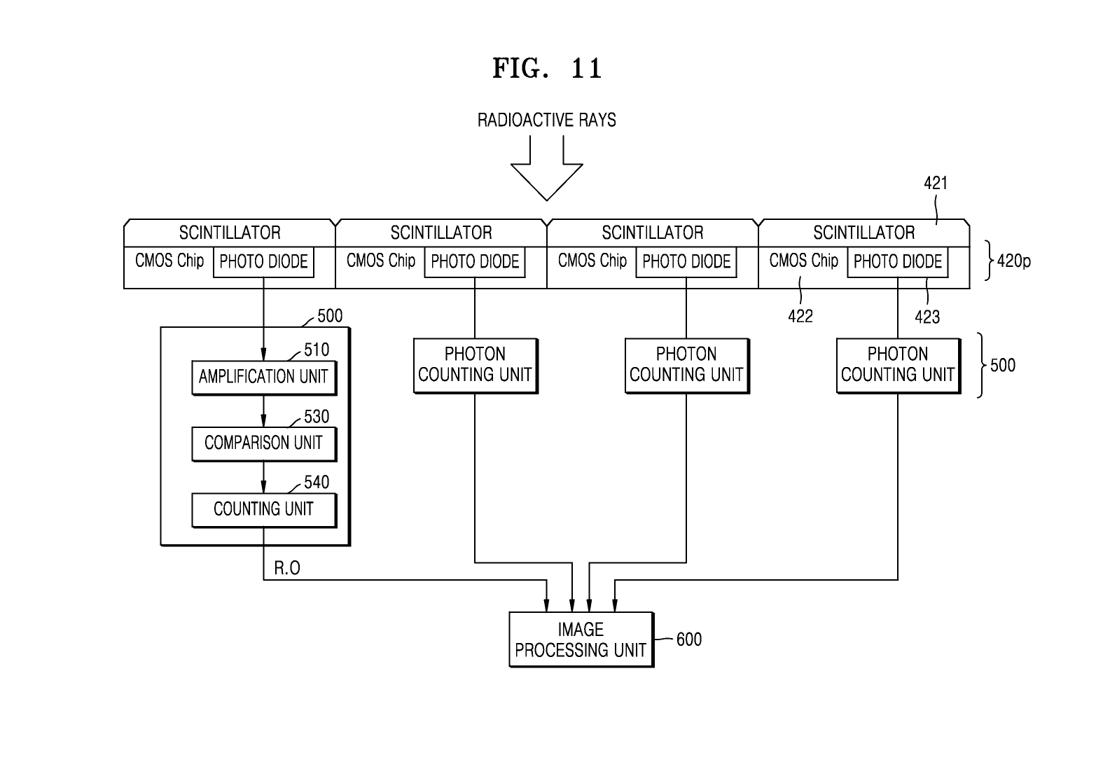

FIG. 11 is a diagram showing each pixel 420p of the PCD apparatus 100 according to another embodiment of the present disclosure. Referring to FIG. 11, each pixel 420p of the PCD apparatus 100 may include a photoelectric conversion unit and the photon counting unit 500. In the current embodiment of the present disclosure, the photoelectric conversion unit detects radioactive rays in an indirect way. More specifically, the photoelectric conversion unit may include a scintillator, a photoelectric element, and a CMOS chip 422 where the photoelectric element is installed. The scintillator is an element for receiving radioactive rays and outputting predetermined photons, for example, visible photons according to the received radioactive rays. The photoelectric element senses visible-ray photons output from the scintillator and outputs an electric signal, that is, a radioactive signal. For example, the photoelectric element may be a photodiode 423. The radioactive signal output from the photoelectric element may be an electric-charge packet. The electric-charge packet may include negative electric charges. As mentioned above, the radioactive signal, that is, the electric-charge packets delivered from the photoelectric conversion unit may be counted and counting result information is output.

The image processing unit 600 may generate a radioactive image based on the counting result information output from the photon counting unit 500. For example, the image processing unit 600 may substitute a predetermined image value for a pixel on a radioactive image corresponding to each pixel according to the intensity of radiation for each pixel to generate the radioactive image. More specifically, if a small number of photons are counted for a predetermined pixel or few photons are counted for the predetermined pixel and thus the intensity of radiation is low, then the image processing unit 600 may generate a predetermined radioactive image such that the pixel of the radioactive image corresponding to the predetermined pixel is marked with a dark color, e.g., the black color. On the other hand, if a large number of photons are counted for a predetermined pixel and thus the intensity of radiation is high, the pixel of the radioactive image corresponding to the predetermined pixel is marked with a bright color, e.g., the white color.

The image processing unit 600 may be a processor installed in a radiographic imaging apparatus or a processor installed in a workstation connected to the radiographic imaging apparatus through a wired/wireless communication network.

The radioactive image generated in the image processing unit 600 may be stored in a storage medium such as a separate magnetic disk or memory chip or may be displayed on the display unit d installed in the radiographic imaging apparatus or an external workstation.

The radioactive image output from the image processing unit 600 may be delivered to an image post-processing unit 610. The image post-processing unit 610 may further correct the radioactive image by modifying a brightness, color, contrast, or sharpness of the radioactive image. In another example, the image post-processing unit 610 may generate a three-dimensional (3D) cubic radioactive image by using a plurality of radioactive images. The post-processed radioactive image may be delivered to and stored in a storage medium, or may be delivered to the display unit d provided in the radiographic imaging apparatus or workstation and displayed to a user.

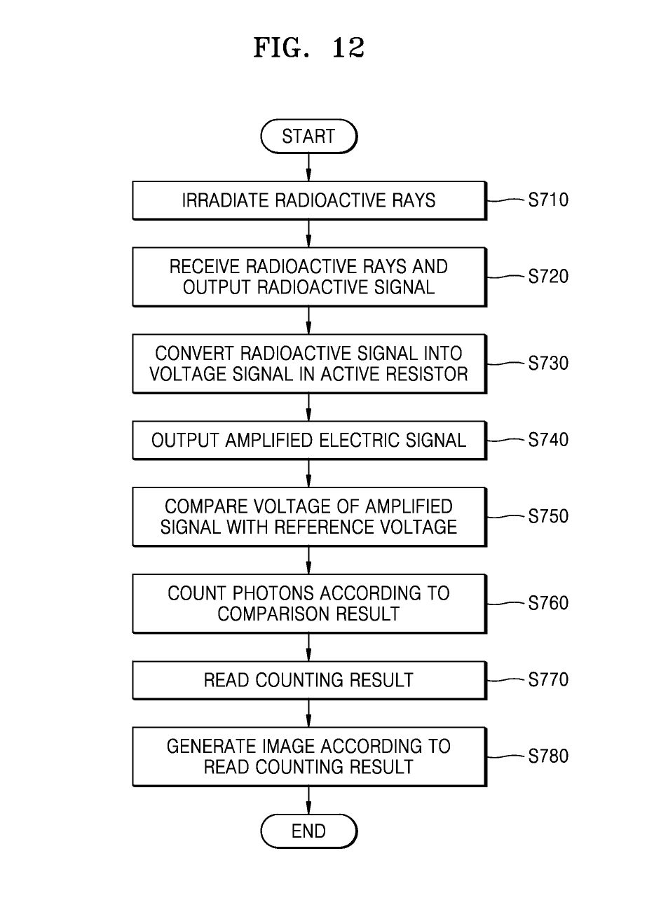

A description will now be made of a method for controlling a radiographic imaging apparatus with reference to FIG. 12.

FIG. 12 is a flowchart illustrating a method for controlling a radiographic imaging apparatus according to an embodiment of the present disclosure. Referring to FIG. 12, in the method for controlling a radiographic imaging apparatus, radioactive rays are generated and irradiated to an object ob in operation S710. The irradiated radioactive rays are attenuated at a predetermined attenuation rate while passing through the object ob.

The radioactive rays attenuated at a predetermined attenuation rate while passing through the object ob and radioactive rays directly arriving without passing through the object ob are received, and an electric signal corresponding to the received radioactive rays, that is, a radioactive signal is output in operation S720.

The output radioactive signal is converted into a voltage signal by the active resistor 131 in operation S730. The voltage signal converted in the active resistor 131 is amplified by the amplifier 135 of the amplification unit 130 and output in operation S740. The amplification unit 130 outputs the amplified radioactive signal and delivers the radioactive signal to the comparison unit 141.

The comparison unit 141 compares a voltage of the amplified radioactive signal with a reference voltage and outputs a comparison result signal in operation S750. The output comparison result signal may be delivered to the counting unit 145.

The counting unit 145 counts the number of photons over the reference voltage according to a comparison result in operation S760.

The counting unit 145 reads a counting result in operation S770, and the image processing unit 600 generates a radioactive image according to the read counting result in operation S780.

An operation may be performed before, simultaneously with, or after at least one of the foregoing operations.

Meanwhile, if a control unit for adjusting a resistance of the active resistor 131 or controlling driving of the active resistor 131 is further provided, the control unit may adjust the magnitude of the voltage signal amplified by the amplification unit 130.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A photon counting detection (PCD) apparatus comprising:
a photoelectric conversion material portion configured to absorb radioactive rays and to generate an electric-charge signal corresponding to an energy of the absorbed radioactive rays;
an amplification unit comprising:
an active resistor configured to convert the electric-charge signal generated by the photoelectric conversion material portion into a voltage signal; and
an amplifier configured to amplify the voltage signal converted by the active resistor; and
a counting unit configured to count the voltage signal converted and amplified by the amplification unit.

2. The PCD apparatus of claim 1, wherein the amplification unit is a negative feedback amplifier.

3. The PCD apparatus of claim 2, wherein the active resistor is connected in parallel to the amplifier.

4. The PCD apparatus of claim 1, wherein the active resistor comprises a P-channel metal oxide semiconductor field effect (PMOS) transistor active resistor or an N-channel metal oxide semiconductor field effect (NMOS) transistor active resistor.

5. The PCD apparatus of claim 1, wherein the active resistor is a cascode circuit including a plurality of transistors connected to one another.

6. The PCD apparatus of claim 1, further comprising an operation supply source configured to drive the active resistor.

7. The PCD apparatus of claim 6, wherein the operation supply source comprises a current source or a resistor.

8. The PCD apparatus of claim 6, wherein the operation supply source is a current source configured to supply a bias current to the amplification unit.

9. The PCD apparatus of claim 6, wherein the operation supply source comprises a resistor control unit configured to control the active resistor.

10. The PCD apparatus of claim 1, further comprising a comparison unit configured to compare the voltage signal amplified by the amplification unit with a reference voltage.

11. The PCD apparatus of claim 1, wherein the amplifier is an operational amplifier.

12. The PCD apparatus of claim 11, wherein the operational amplifier is a common drain amplifier or a common source amplifier.

13. The PCD apparatus of claim 1, wherein the radioactive rays are X-rays or gamma rays.

14. A photon counting detection (PCD) method comprising:
absorbing radioactive rays in a photoelectric conversion material portion and generating an electric-charge signal corresponding to an energy of the absorbed radioactive rays;
inputting the electric-charge signal to an active resistor;
converting the electric-charge signal input to the active resistor into a voltage signal by the active resistor and amplifying the voltage signal; and
counting the amplified voltage signal.

15. The PCD method of claim 14, further comprising driving the active resistor using an operation supply source.

16. The PCD method of claim 15, wherein the operation supply source comprises a current source or a resistor.

17. The PCD method of claim 15, wherein the operation supply source is a current source configured to supply a bias current to the photoelectric conversion material portion.

18. The PCD method of claim 15, wherein the active resistor is controlled through the operation supply source.

19. The PCD method of claim 14, further comprising comparing the voltage signal converted by the active resistor with a reference voltage.

20. A radiographic imaging apparatus comprising:
a photon counting detection (PCD) apparatus comprising:
a photoelectric conversion material portion configured to absorb radioactive rays and to generate an electric-charge signal corresponding to an energy of the absorbed radioactive rays;
an amplification unit comprising:
an active resistor configured to convert the electric-charge signal generated in the photoelectric conversion material portion into a voltage signal; and
an amplifier configured to amplify the voltage signal converted in the active resistor; and
a counting unit configured to count the voltage signal converted and amplified in the amplification unit and to output a counting result; and
an image processing unit configured to perform image processing with respect to the counting result.
